(19) United States
(12) Patent Application Publication
(10) Pub. No.: US 2005/0166410 A1
(43) Pub. Date: Aug. 4, 2005

(54) Machine for simultaneously measuring and compounding angles about multiple axes

(76) Inventors: Lars Richter, Trinity, NC (US); Per Svensson, Gothenburg (SE)

Correspondence Address: DAVID DOUGLAS WINTERS, 2277-C SUITE 237, WILMA RUDOLPH BLVD, CALARKSVILLE, TN, 37040-5898, US

(21) Appl. No.: 10/772,039

(22) Filed: Feb. 4, 2004

(51) Int. Cl. G01C 9/06

(52) U.S. Cl. 33/366.12

(57) ABSTRACT

This patent teaches a machine for measuring angles over multiple simultaneous axes and calculating the compounded angle using tilt sensors and/or accelerometers, and including provision for establishing a baseline or zero point for each axis plus a micro-processor that receives inputs from the tilt sensors, converts them into measurements of angles, may calculate the compound angle(s) thereof, displays the results and, on demand, records the results in memory.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of Invention

This invention relates generally to the field of electronic levels and more specifically to a machine for measuring and for compounding angles about more than one axis at one time.

2. BACKGROUND OF THE INVENTION

Level measuring devices have been known and used for literally thousands of years. The first form was in all probability the free hanging plumb line. With the advent of glass-blowing technology, the bubble level eventually became possible and could be made capable of graphically approximating the attitude of a surface on two axis at once.

In recent decades, new electronic sensing technologies became available that can measure inclination to a precise degree heretofore unknown while being practically impervious to jarring and jolts that would have rendered previous devices useless.

Additionally, prior technology did not provide for establishing arbitrary reference baselines or zero points with respect to which angle could be measured. The reference was always the vertical as defined by gravity.

U.S. Pat. Nos. 5,259,118 and 5,956,260 both to Charles E. Heger, teach electronic inclination sensors/displays that measure inclination about a single axis and show the results in a fan shaped graphic that bears little resemblance to read-outs familiar to professional engineers or construction workers.

U.S. Pat. No. 6,037,874 issued to Gregory Heironimus, also teaches an electronic level measuring device with graphic display that measures angles about a only single axis. U.S. Pat. No. 5,335,190 issued to Nagle et al. discloses an inclinometer for measuring and rescaling an angle about a single axis and digitally displaying the result.

Since prior electronic inclinometer technology could only measure angles about individual axes, independently, then if, for example, one wanted to measure the slope angle of a table that was out of level, one had to measure the slope along two different edges and then use this data to calculate the compound angle. The same problem presents itself to a civil engineer who wants to know the slope of a land surface. The only other manual method for measuring the angle of a plane (avoiding on-the-spot mathematical calculations) was imprecise and involved swinging an inclinometer across the surface, noting the maximum angle displayed during the sweep, that angle being an approximation of the compound angle.

In another example, the driver of a mobile vehicle traversing a meandering course across a slope could not, previously, measure his/her actual maximum angle of tilt. At best, the driver could only determine the angle with respect to one or two given individual axes, neither of which might actually properly aligned to measure the slope of the surface across which the vehicle traveled.

No electronic leveling system has been introduced to precisely measure angles in more than one axis at once and combine them after the natural but imprecise manner of the old bubble level technology familiar to carpenters, for example, world-wide.

### Objects of the Invention

The primary object is to provide an inclinometer/leveling/angle measuring device that can measure angles around two axes at once and display them separately or combine and/or display them as a compound angle.

Another object is to provide an inclinometer that can display single axis or compound angles both graphically and/or in numeric modes.

Another object is to provide an inclinometer that can display angles in discrete and/or continuous modes of increasing preciseness, from approximate to significantly more exacting.

A further object is to provide an inclinometer that can measure angles relative to virtually any chosen observable baseline or reference even those that are remote or distant, using them to establish a baseline or zero point of reference.

A further object is to provide an inclinometer that can record in memory and/or display various measurements for later reference.

Another object is to provide an inclinometer that can measure angles to distant objects or points of reference relative to the vertical or relative to an arbitrary reference angle.

Other objects and advantages will become apparent from the following descriptions, taken in connection with the accompanying drawings, wherein, by way of illustration and example, an embodiment is disclosed.

### BRIEF SUMMARY OF THE INVENTION

In accordance with a preferred embodiment, there is disclosed a machine to measure angles about two axes at once and to calculate the compounded angle. Previous devices in this vein are often termed “inclinometers” or “levels.” This device can measure angles about more than one axis at a time and display the measurements separately or combine and display them as compound angles. The display may be graphic, numerical or both and may manifest discrete or continuous modes of increasing preciseness, from the approximate to the significantly more exacting. The machine may also record results in memory for later display. The zero points or baselines with respect to which measurements are taken may relative to plumb-line vertical or they may be chosen arbitrarily. Further, the device may provide for orientation against remote or distant references.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary but not all-inclusive embodiments that may comprise various forms. It is to be understood that in some instances various aspects may be shown exaggerated or enlarged to facilitate an understanding of the invention.

FIG. 1 is a plan view of the machine showing the display in both numeric and graphic modes.

FIG. 2 contains ¾ views of the machine in vertical and horizontal positions, functioning in graphic mode.

FIG. 3 contains ¾ views of the machine in vertical and horizontal positions functioning in numeric mode

FIG. 4 is a schematic block diagram of the machine.

### LIST OF NUMBERED COMPONENTS FOR EACH FIGURE

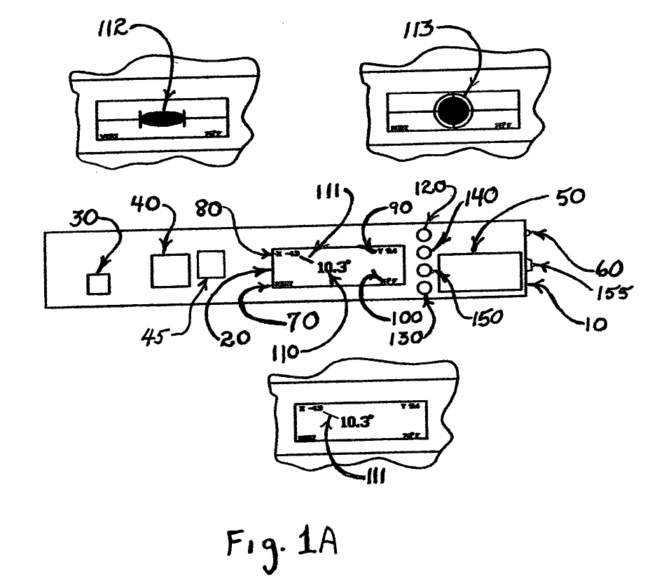

FIG. 1

10 case
20 display screen
30 tilt sensor module
40 microprocessor (contains thermister)
45 alarm
50 power supply and voltage regulator
60 laser reference pointer
70 display orientation mode indicator (numeric format)
80 x-axis angle display (numeric format)
90 y-axis angle display (numeric format)
100 temperature display (numeric format)
110 compound angle display (numeric format)
111 compound angle direction line (numeric format)
112 curved tube bubble level display (graphic format)
113 round dome bubble level display (graphic format)
120 display orientation mode selector
130 on/off/reset button
140 record data selector
150 laser reference pointer control

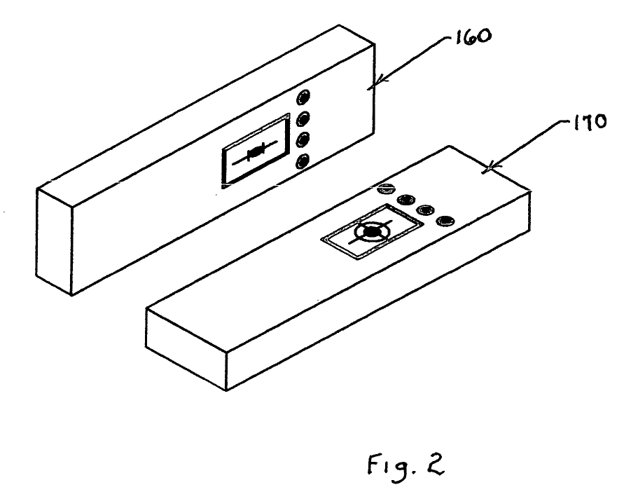

FIG. 2
160 device in vertical position using curved tube bubble level display
170 device in horizontal position using round dome bubble level display

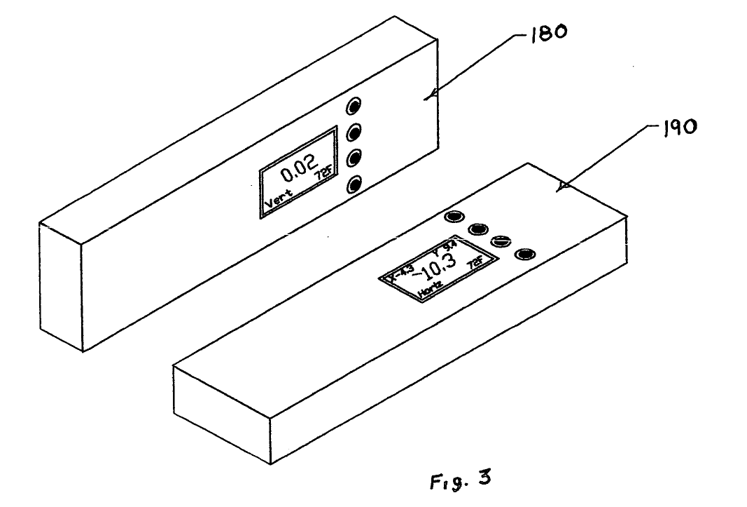

FIG. 3
180 device in vertical position using numeric display
190 device in horizontal position using numeric display

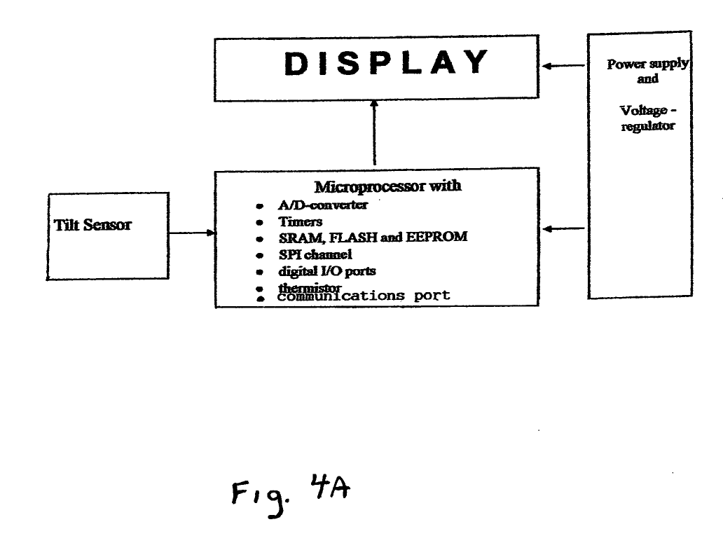

FIG. 4
20 display screen
30 tilt sensor module
40 microprocessor (contains thermister)
50 power supply and voltage regulator

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the technology presented in virtually any appropriately detailed system, structure or manner.

Referring first to FIG. 1 there is depicted a plan view in the preferred mode showing the display in both numeric format (20) and graphic format (112 and 113). The case (10) made of a rigid substance such as, for example, plastic, wood, ceramics, or metal, is used to mount and contain the several components and is used to orient the device by pressing it against solid objects or by training the laser pointer (60) on distant points on objects in order to measure the angles to or of those objects. The tilt sensor module (30) contains two sensors each oriented about a different axis, the axes being normal to each other and lying in the same plane.

When the device is in use, the microprocessor (40) and display screen (20) are energized by the power supply/voltage regulator that is, in preferred mode depicted, a 9 volt dry cell (50). The microprocessor (40) receives data inputs from the tilt sensors (30) converts the data into usable information as to discrete and/or compound angles. It also receives and processes the output of its thermister to generate a temperature display output (100). The microprocessor (40) then forwards the results for display on the display screen (20) in numeric format (110), graphic horizontal (curved-tube bubble-level like) display format (112), or graphic vertical (round-dome bubble-level like) display format (113).

The format button (120) is used to select the display format (numeric or graphic) preferred. The “ON/OFF/RESET” button (130) is used to switch the machine on and off and to internally mark a particular orientation of the machine for use as a baseline/zero point against which subsequent angles may be measured. The memory button (140) is used to record measurements and calculations for later reference. The laser button (150) is used to activate the laser reference pointer (60).

To exercise this embodiment, one presses the “ON/OFF/RESET” button (130) and orients the measuring device by pressing the case against one surface the angle of which one desires to measure. The display screen (20) will then show numeric or graphic information relative to the vertical as defined by gravity. (The device will automatically generate its output values according to whether it is positioned with its display facing upward or with facing to one side.) At this point, one may simply observe the information, or record the information by pressing the “MEMORY” button (140).

Additionally, one may again press the “ON/OFF/RESET” button (130) to redefine the baseline/zero point to equal the present orientation. Then the device may be moved to a new position and it will measure the new angle inscribed relative to the orientation had at the time the “ON/OFF/RESET” button was last pushed. At this point, the output values may again be observed or they may be recorded by pushing the “MEMORY” button (140) for later reference.

If the user desires to measure an angle to a remote point, he/she may substitute the laser reference pointer (60) for physical contact with the surfaces to receive angular measurement. Instead of the pressing the device against the surface(s) in question, the user activates the laser reference pointer by pressing the “LASER” button (150) and trains it on the distant reference point to orient the device. The user then otherwise proceeds as described above.

The user may alternate the display formats by pressing the “MODE” button (120). If the display is in “graphic” format, the micro-processor converts the output data to a graphic display resembling a carpenters bubble level. In this format, if the device is oriented with its display screen (20) to one side, the image displayed will resemble a curved-tube bubble-level (112) measuring an angle about only one axis. If the device is oriented with its display screen (20) pointing upward, the image displayed will resemble a dome-shaped bubble level (113), exhibiting the compound angle measured and calculated with reference to two axes.

If the display is in “numeric” format, it will initially exhibit a single angle relative to the vertical. Set to use such a format, if the display screen is facing to one side (i.e. is substantially normal to a horizontal plane) the “display mode indicator” will spell out ‘VERT’. However, if the display screen is facing upward (i.e. substantially parallel to a horizontal plane), it will it will initially exhibit the angles about two axis normal to each other, plus their compound angle. The “display mode indicator” will spell out “HORIZ.” As a design option, the “display mode indicator” also may be rigged to exhibit a “compound angle direction line” (111) showing the direction along which this compound angle lies. When in the “numeric” format, the preferred embodiment also measures and displays the temperature (100) as measured by the thermister in the microprocessor (40), which may be useful in calculating material expansion/contraction corrections with respect to the physical entities dealt with.

When the device is powered up and oriented, the angular measurements are sampled repeatedly at frequent intervals. The values and calculated results of each measurement are continuously averaged into any immediately previous results to refine the accuracy of the final output. Thus, while the device remains stationary, accuracy of the final output may be increased to a high degree of precision within a period of several seconds.

FIG. 2 is a schematic block diagram of the machine showing the micro-processor (20) that is central to the machine, incorporating an analog to digital converter, timers, digital input/output ports, SRAM, FLASH and EPROM circuits, a thermister for measuring temperature and an SPI channel. The figure relates this processor (40) to the tilt sensor module (30), the display screen (20), the “ON/OFF/RESET” button (30), the “MODE” button (120), the “MEMORY” button (140), the “LASER” button (150), and the power supply/voltage regulator (50), powering both the microprocessor (40), display screen (20), and communications port (155).

While described herein is a preferred embodiment, it is not intended to limit the scope to the particular form set forth, but on the contrary, it is intended to cover such alternatives, modifications, and equivalents as may be included within the spirit and scope as defined by the appended claims.

1) a machine for measuring angles about a plurality of axes, comprising:
one or more multi-axis gravity sensing tilt sensor(s) or inertial accelerometer(s) or multiple gravity sensing tilt sensor(s) or inertial accelerometer(s), situated about different axis;
a computing device that receives inputs from the said gravity sensing tilt sensor(s) or inertial accelerometer(s), translates them into expressions of angular measurement and outputs the results for display, computation, or extraction; and a means of mounting components, comprising a case.

2) a machine for measuring angles about a plurality of axes, comprising:
one or more multi-axis gravity sensing tilt sensor(s) or inertial accelerometer(s), or multiple gravity sensing tilt sensor(s) or inertial accelerometer(s), situated about different axis; and
a computing device that receives inputs from the said gravity sensing tilt sensor(s) or inertial accelerometer(s), translates them into expressions of angular measurement, calculates compounded angles of the various angles it measures and outputs the results for display, computation, or extraction;

3) a machine as in claims (1) or (2) wherein a means of information extraction is incorporated, comprising a communications port or electromagnetic transmitter.

4) a machine as in claim (1) or (2) that displays the results of the measurements and/or calculations in graphic form.

5) a machine as in claim (4) wherein multiple displays may be exhibited simultaneously.

6) a machine as in claim (4) wherein multiple displays may be exhibited sequentially.

7) a machine as in claim (4) wherein multiple displays modes are controllable, being user selectable to exhibit simultaneously or sequentially.

8) a machine as in claim (4) wherein one or more graphic displays resemble the form of a bull's-eye bubble level with scales.

9) a machine as in claim (4) wherein one or more graphic displays resemble the form of a curved-tube bubble level with scales.

10) a machine as in claim (4) wherein the displays appear on different faces of the machine's case according to the axis about which the measurements or calculations producing them are made.

11) a machine as in claim (4) that, having calculated a compound angle, can display a line representing the edge of the plane in which that angle lies.

12) a machine as in claim (1) or (2) that displays the results of the measurements and/or calculations in numeric form.

13) a machine as in claim (12) wherein multiple displays may be exhibited simultaneously.

14) a machine as in claim (12) wherein multiple displays may be exhibited sequentially.

15) a machine as in claim (12) wherein multiple displays modes are controllable, being user selectable to exhibit simultaneously or sequentially.

16) a machine as in claim (12) wherein the displays appear on different faces of the machine's case according to the axis about which the measurements or calculations producing them are made.

17) a machine as in claim (12) that, having calculated a compound angle, can display a line representing the edge of the plane in which that angle lies.

18) a machine as in claim (1) or (2) wherein the display format is user controllable, allowing selection of either graphic or numeric format.

19) a machine as in claim (18) wherein multiple displays may be exhibited simultaneously.

20) a machine as in claim (18) wherein multiple displays may be exhibited sequentially.

21) A machine as in claim (18) wherein multiple displays modes are controllable, being user selectable to exhibit simultaneously or sequentially.

22) a machine as in claim (18) wherein one or more graphic displays resemble the form of a bull's-eye bubble level.

23) a machine as in claim (18) wherein one or more graphic displays resemble the form of a curved-tube bubble level.

24) a machine as in claim (18) wherein the displays appear on different faces of the machine's case according to the axis about which the measurements or calculations producing them are made.

25) a machine as in claim (18) that, having calculated a compound angle, can display a line representing the edge of the plane in which that angle lies.

26) a machine as in claims (1) or (2) wherein angles may be measured and/or calculated in multiple modes comprising various levels of precision and of speed of measurement and/or calculation.

27) a machine as in claim (26) wherein the modes of measurement and/or 9 calculation may be selected automatically by the machine itself.

28) A machine as in claim (26) wherein the modes of measurement and/or calculation may be manually selected by the user.

29) a machine as in claims (1) or (2) wherein one or more means of orienting the device with respect to distant or remote reference points is incorporated, these means being preferably by use of a laser light or other electromagnetic energy beam projected from the device, but also including optical sight or reticule, audio beam, mechanical arm or extension, or any other manner of remote reference.

30) a machine as in claims (1) or (2) wherein the measurements and results of calculations may be recorded and later displayed or output for reference.

31) a machine as in claims (1) or (2) wherein the computing component can automatically select a display mode in accordance with the orientation of the device as detected by the gravity sensing tilt sensor(s) or inertial accelerometers.

32) a machine as in claim (1) or (2) wherein the ambient temperature is measured and displayed for calibration purposes.

33) a machine as in claim (1) or (2) wherein a discrete signal, audio, visual, or electrical, is emitted when the unit attains one or more predetermined angular position(s).

34) a machine as in claim (1) or (2) wherein an alarm signal is emitted that varies in accordance with the machine's proximity to pre-determined angles;

35) a machine as in claim (1) or (2) also comprising a means of recording, or of storing in a memory, a baseline or zero point for each axis from whence angles may be measured;

36) a machine as in claim (1) or (2) wherein the functions of angular measurement may be set to reset to zero at pre-determined or user selected angles, presenting, at each applicable angle, a simulated bubble level display exhibiting an inclination reading of zero.
